(19) United States
(12) Patent Application Publication
(10) Pub. No.: US 2012/0210814 A1
(43) Pub. Date: Aug. 23, 2012

(54) Cable Transmission Shift Converter

(76) Inventors: Robert L. Jones, JR., Montgomery, AL (US); Steve Phillips, Tallassee, AL (US)

(21) Appl. No.: 13/031,974

(22) Filed: Feb. 22, 2011

(51) Int. Cl. F16C 1/14; B23P 11/00

(52) U.S. Cl. 74/473.15; 29/525.01

(57) ABSTRACT

A cable transmission shift converter for use when replacing the transmission in a right hand drive vehicle with a transmission designed for a left hand drive vehicle. A mounting bracket is mounted directly to a firewall adjacent the steering column of the vehicle, while a second angled bracket is mounted to the left side of the replacement transmission. When the driver shifts the vehicle into gear, the steering column shift selector lever actuates a connector rod to transmit movement through the control cable to a second connector rod, which activates a crank arm that translates the movement to the transmission shift lever.

### CROSS-REFERENCE TO RELATED APPLICATIONS

This application claims the benefit of U.S. Provisional Application No. 60/855,816, filed Nov. 1, 2006, which is incorporated herein by reference.

### FIELD OF THE INVENTION

This invention relates to a cable transmission shift converter for use in the installation of a vehicle transmission, particularly for use when replacing the transmission in a right hand drive vehicle with a transmission designed for a left hand drive vehicle. More particularly, the invention relates to a shift mechanism with a reduced number of wear points. Additionally, the invention relates to a shift mechanism that is mountable closer to the steering column shift selector lever, reducing the need of readjustment.

### BACKGROUND OF THE INVENTION

The United States Postal Service utilizes Grunman LLV-A vehicles built on a S-10 chassis, referred to as “LLV Delivery Trucks” for mail delivery. The original equipment transmissions in LLV Delivery Trucks are General Motors (“GM”) 180 C transmissions. The LLV Delivery Trucks are right hand drive vehicles, and accordingly, the GM 180 C transmission shifts on the right side of the unit. Because of a history of numerous transmission failures associated with the use of GM 180 C transmissions in LLV Delivery Trucks, the U.S. Postal Service elects to substitute in these vehicles a stronger transmission such as, for example, the GM 700R4 transmission.

The GM 700R4 transmission is used as original equipment in Chevy S-10 pickup trucks. The GM 700R4 transmission and other suitable replacements are made for left hand drive vehicles and shift on the left side of the unit. Thus, in order to install the left hand drive replacement transmissions in a LLV Delivery Truck, it is necessary to connect the LLV shift rod to the transmission in a manner that permits successful control of the transmission. Such a connection has previously been accomplished by a right-to-left changeover linkage connecting the shift rod on the right side of the vehicle to the transmission shift lever on the left side of the transmission. U.S. patent application Ser. No. 09/865,157, filed May 24, 2001 and published as Pub. No. US 2003/0041684, discloses a cable transmission shift converter that includes a bell crank and a bracket connected directly to the car's frame. However, this cable transmission shift mechanism has many different components which add to the expense of the device. Additionally, with the high number of different components, the number of wear points is high. Also, the combination of the cable shift mechanism being connected to the car frame and all the moving parts requires a great deal of time adjusting the components with the transmission and the steering column shift selector lever to ensure proper alignment. Accordingly, there remains a need for a cable transmission shift converter that has fewer parts, reducing the production costs and wear points. Additionally, there remains a need for a cable transmission shift converter that is mountable closer to the steering column shift selector lever, ensuring less time needed for connecting and aligning the device.

### SUMMARY OF THE INVENTION

The present invention is an apparatus that permits the use in a vehicle of a transmission that shifts on a different side from that of the original equipment transmission. An embodiment of the invention permits reliable use of the a left hand drive transmission in LLV Delivery Trucks and other vehicles that originally used right hand drive transmissions, where the transmission shift lever is on the right side of the transmission. The cable shift converter transmits movement of the steering column shift selector lever, on the right side of the vehicle, to the transmission shift lever located on the left side of the replacement transmission.

In one embodiment, the cable shift converter includes two brackets, a steering column bracket and an angled bracket, and a control cable. The steering column bracket is mounted directly to a firewall adjacent the steering column, while the angled bracket is mounted to the left side of the replacement transmission. The control cable is attached to the steering column bracket at a first end of the control cable and the angled bracket at a second end of the control cable. The control cable may be made from polytetrafluoroethylene (PTFE)-coated (Teflon® brand) marine cable, thereby preventing the control cable from rusting or freezing. A connector rod is coupled to each end of the control cable. A steering column connector rod at the first end of the control cable is coupled to the steering column shift selector lever using a clevis, a pin, and a bushing. The second end of the control cable is attached to the angled bracket and is coupled to a transmission connector rod. The transmission connector rod is coupled to a crank arm using a clevis and a pin, and the crank arm is coupled to the transmission shift lever on the left side of the transmission. When the driver shifts to “reverse” or “drive,” the steering column shift selector lever moves the steering column connector rod. This translates the movement to the control cable, which activates the transmission connector rod. The movement of transmission connector rod causes the crank arm to actuate, thereby translating the movement to the transmission shift lever.

### BRIEF DESCRIPTION OF THE DRAWINGS

FIG. 1 is a perspective view of a prior art cable shift converter with a transmission.

FIG. 2 is a detailed view of the prior art shift rod adapter portion shown in FIG. 1.

FIG. 3 is a perspective view of an embodiment of the cable converter of the present invention connected to a transmission to illustrate a typical relationship of the cable shift converter to the transmission.

FIG. 4 is a detailed view of an embodiment of the steering column adapter portion of the embodiment of the present invention shown in FIG. 3.

FIG. 5 is a detailed view of an embodiment of the transmission shift lever adapter portion of the embodiment of the present invention shown in FIG. 3.

### DETAILED DESCRIPTION OF THE INVENTION

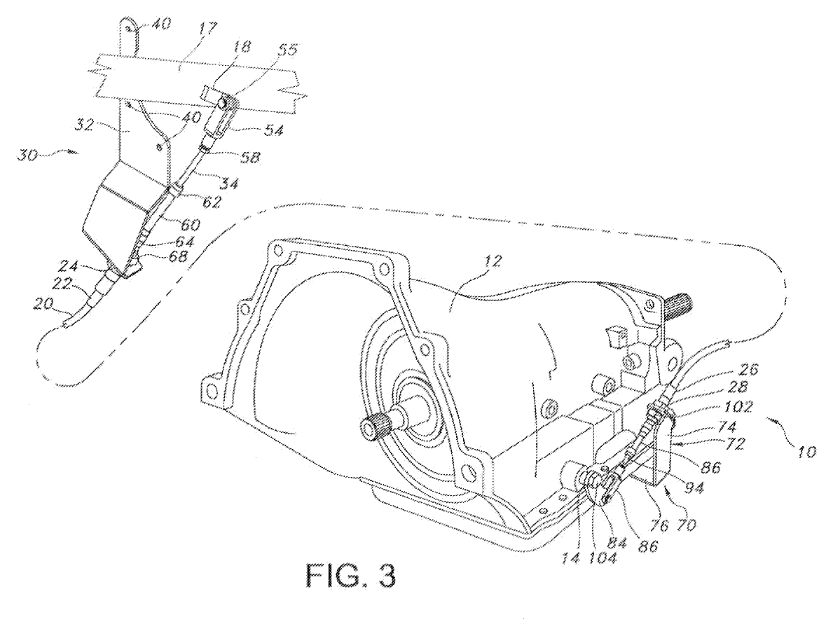

A cable shift converter 10 of this invention is depicted in FIG. 3, which shows the relationship of cable shift converter 10 to a transmission 12. Cable shift converter 10 consists of a control cable 20, a steering column adapter 30, and a transmission shift lever adapter 70. Cable shift converter 10 allows a user to replace a right-hand shift transmission with a left-hand shift transmission in a vehicle originally designed to use the right-hand shift transmission.

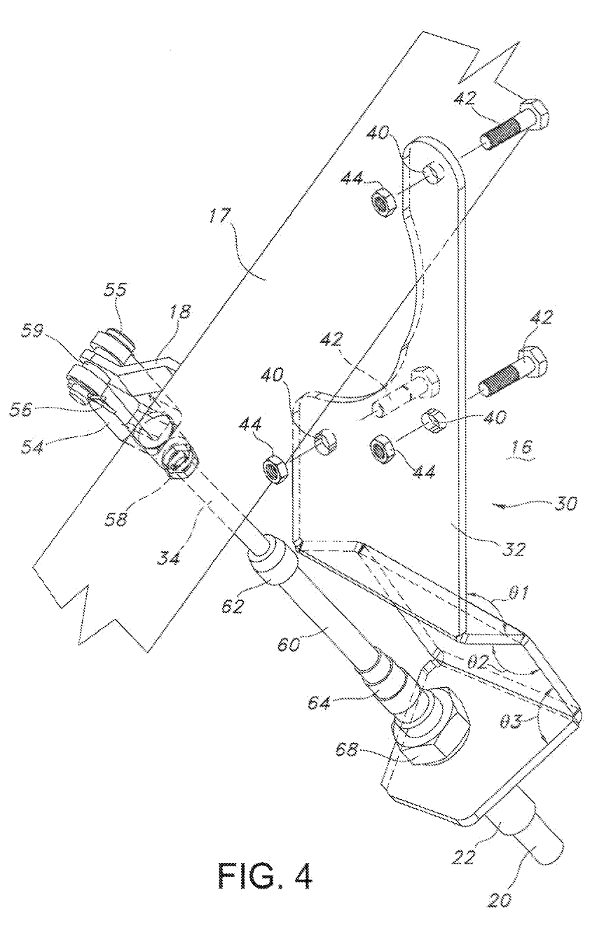

Referring to FIGS. 3 and 4, steering column adapter 30 is formed from a steering column bracket 32 and a steering column connector rod 34. The steering column bracket 32 is mounted directly to a firewall 16 of a vehicle adjacent the steering column 17. The firewall 16 provides a barrier between the engine compartment and the passenger compartment of the vehicle. The steering column bracket 32 contains three integrally-formed holes 40 for attaching the steering column bracket 32 to firewall 16. In order to secure the steering column bracket 32 to firewall 16, the holes 40 are aligned with pre-existing bolts 42 extending from the steering column support of the firewall 16. Lock washer nuts 44 may be used to secure the steering column bracket 32 on the bolts 42.

The steering column bracket 32 is formed from a metal plate that is bent into shape and contains multiple bends that facilitate mounting and operation of the control shift converter. The angles of each of three bends are marked in FIG. 4 as θ1, θ2, and θ3. In a preferred embodiment, θ1 is approximately 120 degrees, θ2 is approximately 150 degrees and θ3 is approximately 95 degrees.

The steering column connector rod 34 is connected to control cable 20 at one end and to a steering column shift selector lever 18 at the other end. The steering column connector rod 34 is connected to the steering column shift selector lever 18 using a clevis 54, a pin 55, a cotter pin 56, and a bushing 59. The pin 56 is extended through the clevis 54 and the bushing 59 and an integrally-formed hole (not shown) in the steering column shift selector lever 18. The clevis 54 is threaded onto the connector rod 34 and locked in place with a nut 58.

The steering column connector rod 34 is connected to the control cable 20 inside a sheath that covers the control cable 20. A guide tribe 60 acts as a casing to cover and protect the connector rod 34 as it extends and retracts upon movement of the steering column shift selector lever 18. Dust boots 62 and 64 at each end of guide tube 60 facilitate smooth movement of the steering column connector rod 34 and protect the device from dust and debris where the connector rod 34 enters and exits guide tube 60. A nipple 22 at one flexible end of control cable 20 extends through and is attached to steering column bracket 32 by nuts 24 and 68 that trap the steering column bracket 32. The control cable 20, steering column connector rod 34, and guide tube 60 may be assembled or connected piece by piece. Alternatively, a single cable assembly unit including control cable 20, its outer sheath, connector rods 34 and 94, guide tubes 60 and 96, dust boots 62, 64, 98, and 100, nipples 22 and 26, and locking nuts 24, 28, 68, and 102 may be purchased through the Orscheln Group, which can be contacted at 8351 County Rd. 245, PO Box 68, Holmesville, Ohio 44633.

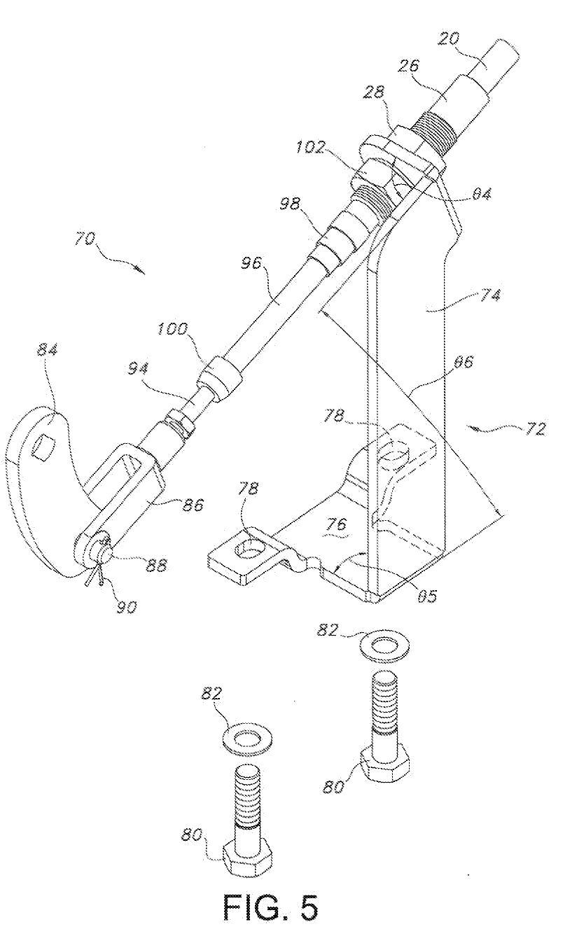

The transmission shift lever adapter 70, shown in FIGS. 3 and 5, is formed from an angled bracket 72, a crank arm 84, and a transmission connector rod 94. The angled bracket 72 consists of a bent plate 74 and a flat metal plate 76 welded or otherwise attached to bent plate 74. The metal plate 76 is penetrated by two holes 78 for receiving bolts 80 to secure the angled bracket 72 to transmission 12. Bolts 80 extend through holes 78 that are aligned with holes in the bottom of the transmission oil pan. Washers 82 are used between bolts 80 and the angled bracket 72.

The crank arm 84 is coupled to the transmission connector rod 94 at one end and to a transmission shift lever 14 at another end, as shown in FIG. 3, to convert linear movement of control cable 20 into rotation of transmission shift lever 14. The transmission shift lever 14 is threaded and slides into a slot in crank arm 84, and a nut 104 is used to secure this connection. The transmission shift lever 14 is a part of the transmission 12. The crank arm 84 is shaped so that it may travel around and avoid contact with the oil pan of the transmission, which protrudes out from the transmission 12. The crank arm 84 is connected to the transmission connector rod 94 using a clevis 86, a pin 88, and a cotter pin 90, as shown in FIG. 5. The clevis 86 is threaded onto connector rod 94 and locked in place with a nut 92.

The connector rod 94 extends from the crank arm 84 to the control cable 20. A guide tube 96 acts as a casing to cover and protect the transmission connector rod 94 as it extends and retracts upon movement of the control cable 20. Dust boots 98 and 100 are at each end of the guide tube 96 to facilitate smooth movement of the connector rod 94 and to protect the device from dust and debris at the contact points between the guide tube 96 and the connector rod 94.

A nipple 26 at one flexible end of the control cable 20 extends through and is attached to the angled bracket 72 by nuts 28 and 102 that trap the angled bracket 72. The angles of the two bends in angled bracket 72 are marked in FIG. 5 as θ4 and θ5. In a preferred embodiment, θ4 and θ5 are approximately 90 degrees. Additionally, the angle between the plane of flat metal plate 76 and the plane of the portion of angled bracket 72 around which nuts 28 and 102 are located is approximately 75 degrees in a preferred embodiment. This angle is marked as θ6 in FIG. 5.

The control cable 20 is attached between the steering column adapter 30 and the transmission shift lever adapter 70. At one end, the control cable 20 is attached to the steering column bracket 32 and coupled to the steering column connector rod 34, which is coupled to the steering column shift selector lever 18. At its other end, the control cable 20 is attached to the angled bracket 72 and coupled to the transmission connector rod 94, and the connector rod 94 is coupled to the crank arm 84, which is coupled to the transmission shift lever 14.

When the driver shifts to “reverse” or “drive,” the steering column shift selector lever 18 is actuated, causing the steering column connector rod 34 to move. This connector rod 34 translates the movement to the control cable 20, which activates the transmission connector rod 94. The movement of the transmission connector rod 94 causes the crank arm 84 to move thereby translating the movement to the transmission shift lever 14. When the driver moves the steering column shift selector lever 18 from park to a gear, the cable shift converter 10 causes the transmission shift lever 14 to move, making the transmission shift to the proper gear selected. Since the cable shift converter 10 connects directly to the steering column shift selector lever 18, the shift points are exact and no adjustments are needed.

Before installing the cable shift converter 10, it is critical to ensure that the vehicle is in park. If a cable transmission shift converter of another nature has been attached beforehand, it must be removed. For example, if the transmission shift converter disclosed in U.S. patent application Ser. No. 09/865,157 was attached, the shift rod must be disconnected from the steering column while retaining the connecting bushing 59. Additionally, the shift rod adapter must be removed from the frame, as well as the transmission shift lever adapter from the transmission plate. Lastly, the crank arm must be disconnected from the transmission shift lever.

Once the vehicle is ready for the cable shift converter to be installed, the cable shift converter 10 should be inserted to the right side of the steering column of the vehicle. The steering column bracket 32 is then secured against the firewall 16 by aligning the holes 40 with the pre-existing bolts 42 extending the firewall 16 and secure with the lock washer nuts 44. The steering column connector rod 34 is then attached to the steering column shift selector lever 18. The clevis 54 is inserted through the bushing 59 and the integrally-formed hole in the steering column shift selector lever 18. The locking pin 56 secures the clevis 54 with the bushing 59 and selector lever 18.

The control cable 20 and the transmission shift lever adapter 70 is then routed around the driveshaft of the vehicle. Once in the desired position, the angled bracket 72 is then attached to the transmission. Bolts 80 are placed and secured through the two holes 78 that are aligned with holes in the bottom of the transmission oil pan. The crank arm 84 is next attached to the transmission shift lever 14 of the transmission 12. When attaching the crank arm, the transmission shift lever 14 should be in the park position. The transmission shift lever 14 is threaded and slides into a slot in crank arm 84, and a nut 104 is used to secure this connection. Finally, the control cable 20 is then secured to the underside of the vehicle with a tie wrap. Upon completion, all gears should be shifted through in order to ensure proper adjustment.

For a preferred embodiment, the crank arm 84 is approximately 1 inch wide and about 3 inches in length. For alternate embodiments, the above dimensions of the crank arm 84 would need to be adjusted to produce the desired result, which is that a particular quantity of movement of the steering column shift selector lever 18 produces the corresponding movement in the transmission shift lever 14. The dimensions of the crank arm 84 would differ depending on the model of transmission and the model of vehicle into which the transmission is placed. Furthermore, for alternate embodiments, angles θ1 through θ6 may also vary, depending on the model of transmission and vehicle, in order to produce the desired result.

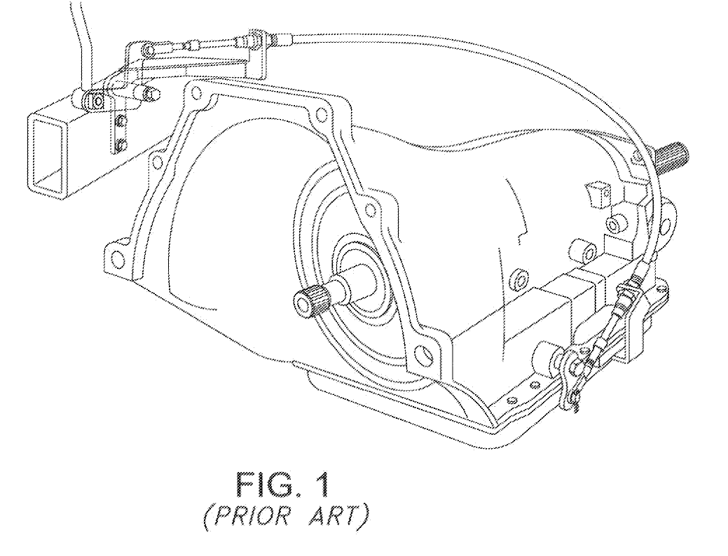

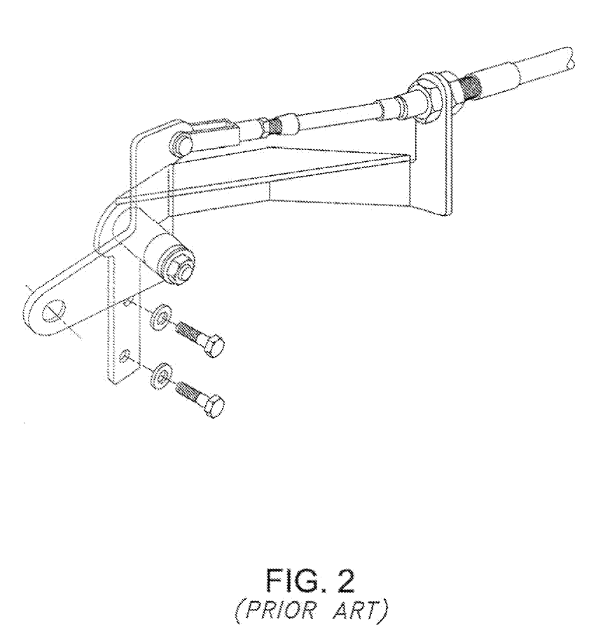

This cable shift converter has several benefits over other systems currently in use. For example, the prior art system described in U.S. patent application Ser. No. 09/865,157, and shown in FIGS. 1 and 2, requires many moving parts to work with one another to convert the action of a driver shifting into shifting the transmission. The steering column shift selector lever is connected to a down rod, which is connected to a bell crank. The bell crank is connected to a mounting bracket via a rotatable sleeve and connects to a shift rod which is connected to a control cable.

Certain embodiments of this invention have only a steering column bracket and a rod connector, greatly reducing production costs and eliminating wear points. Additionally, since the control cable is connected to the steering column shift selector lever through only the rod connector and is mounted to the firewall adjacent the steering column, less time is needed to properly align and connect the cable shift converter. Since the steering column bracket are connected at a higher point within the vehicle, the cable shift converter's exposure to inclement weather conditions is greatly reduced, which reduces the risk of damage to the converter. Lastly, the configuration of the converter and its connection points with the steering column shift selector lever duplicates the shift feel of an original connection. The connection with invention of U.S. application Ser. No. 09/865,157 would result in irregular shifting sensation, as if the gears were not matching the drivers shift commands. The connections of the present invention line up in a manner similar to an original connection, resulting in a natural feel. This cable shift converter may be easily installed without the removal of many other vehicle parts and will not interfere with or require modification of any vehicle parts when installed. Finally, because it is mounted to the firewall of the vehicle and the transmission and utilizes flexible cable, cable shift converter 10 is not required to be removed when performing vehicle maintenance.

The cable transmission shift converter of this invention overcomes many disadvantages associated with other types of transmission shift converters or adapters currently in use. As will be understood by one skilled in the art, the details of the structure depicted in the accompanying drawing and described above can be varied without departing from the scope or spirit of this invention or the following claims. For instance, modifications can be made in the exact shapes and dimensions of the above-described components, and other components can be substituted while continuing to provide a transmission shift converter that is sturdy, accurate, durable, and highly functional.

What is claimed is:

1. A transmission shift converter for coupling a shift selector lever positioned within a vehicle on one side of a transmission to a transmission shift control protruding from the opposite side of the transmission, the converter comprising:
(a) a first bracket mountable to a firewall adjacent a steering column of the vehicle;
(b) a second bracket mountable to the transmission;
(c) a flexible cable connected between the first bracket and the second bracket;
(d) a rod having first and second ends, the first end of the rod being coupled adjacent an end of the cable that terminates at the first bracket; and
(e) a clevis pin coupled to the second end of the rod and attachable directly to the shift selector lever of the vehicle.

2. The transmission shift converter of claim 1, further comprising a second rod having first and second ends, the first end of the second rod being coupled adjacent a second end of the cable that terminates at the second bracket and the second end of the rod being coupled to a crank arm that is attachable to the transmission shift control protruding from the transmission.

3. The transmission shift converter of claim 2, wherein each of the first and second rods are threaded onto an end of the cable.

4. The transmission shift converter of claim 1, wherein the cable is coated with polytetrafluoroethylene (PTFE).

5. The transmission shift of claim 1, wherein the first bracket comprises metal bent in three places to form four portions.

6. The transmission shift converter of claim 5, wherein the first bracket further comprises:
(a) a first portion proximate an end of the first bracket comprising an opening at which the first end of the rod and the end of the cable terminating at the first bracket are coupled; and
(b) a second portion proximate an opposite end of the first bracket comprising at least one opening for receiving a bolt to mount the first bracket to the firewall.

7. The transmission shift converter of claim 6, wherein the first bracket further comprises:
(a) a third portion that extends from the first portion at an angle of approximately ninety-five degrees in a direction opposite the cable; and
(b) a fourth portion between the third portion and the second portion that extends toward the first rod and extends from the third portion at an angle of approximately one-hundred fifty degrees;
wherein the second portion extends away from the first rod, and extends from the fourth portion at an angle of approximately one hundred twenty degrees.

8. The transmission shift converter of claim 7, wherein the first portion of the first bracket travels through a first generally vertical plane, and the second, third, and fourth portions of the first bracket travel through a second generally vertical plane, wherein the first vertical plane and the second vertical plane intersect.

9. The combination of a transmission and a transmission shift control converter for coupling a shift selector lever positioned within a vehicle positioned on one side of the transmission to a transmission shift control protruding from an opposite side of the transmission, the combination comprising:
(a) the transmission;
(b) a first bracket mountable to a firewall adjacent a steering column of the vehicle;
(c) a second bracket mountable to the transmission;
(d) a flexible cable connected between the first bracket and the second bracket;
(e) a rod having first and second ends, the first end of the rod being coupled adjacent an end of the cable that terminates at the first bracket; and
(f) a clevis pin coupled to the second end of the rod and attachable directly to the shift selector lever of the vehicle.

10. A transmission shift converter for coupling a shift selector lever positioned within a vehicle on one side of a transmission to a transmission shift control protruding from an opposite side of the transmission, the converter comprising:
(a) a first bracket mountable to a firewall adjacent a steering column of the vehicle;
(b) a second bracket mountable to the transmission;
(c) a flexible cable connected between the first bracket and the second bracket;
(d) a rod having first and second ends, the first end of the rod being coupled adjacent an end of the cable that terminates at the first bracket; and
(e) a clevis pin coupled to the second end of the rod and attachable directly to the shift selector lever of the vehicle;
wherein the first bracket comprises metal bent in three places to form four portions of the first bracket comprising:
(i) a first portion with an opening at which the first end of the rod and the end of the cable terminating at the first bracket are coupled;
(ii) a second portion extending from the first portion at an angle of approximately ninety degrees in a direction opposite the cable;
(iii) a third portion extending toward the first rod and extending from the second portion at an angle of approximately one-hundred sixty-five degrees; and
(iv) a fourth portion having at least one opening for receiving a bolt to mount the first bracket to the firewall, extending away from the first rod, and extending from the third portion at an angle of approximately one hundred degrees.

11. A method for installing a transmission shift converter to a shift selector lever positioned on one side of a transmission to a transmission shift control protruding from an opposite side of the transmission of a vehicle, the method comprising:
(a) providing the transmission shift converter, the shift converter comprising:
(i) a first bracket;
(ii) a second bracket;
(iii) a flexible cable connected between the first bracket and the second bracket;
(iv) a rod having first and second ends, the first end of the rod being coupled adjacent an end of the cable that terminates at the first bracket; and
(v) a clevis pin coupled to the second end of the rod;
(b) mounting the first bracket to a firewall adjacent to a steering column of the vehicle;
(c) coupling the clevis pin to the shift selector lever of the vehicle; and
(d) mounting the second bracket to the transmission.

12. The method of claim 11, wherein the transmission shift converter further comprises a second rod having first and second ends, the first end of the second rod being coupled adjacent a second end of the cable that terminates at the second bracket and the second end of the second end of the rod being coupled to a crank arm and further comprising coupling the crank arm to the transmission shift control after mounting the second bracket to the transmission.

13. The method of claim 12, further comprising securing the cable to an underside of the vehicle after coupling the crank arm to the transmission shift control.

14. The method of claim 11, further comprising removing a previously-installed shift mechanism before mounting the first bracket.

15. The method of claim 11, further comprising routing the transmission shift converter above a driveshaft of the vehicle after coupling the clevis pin to the shift selector lever and before mounting the second bracket to the transmission.

16. The method of claim 11, wherein mounting the first bracket further comprises mounting the first bracket by aligning a plurality of holes in the first bracket with a plurality of bolts extending from the firewall and securing the first bracket with a plurality of nuts.
